(19) United States
(12) Patent Application Publication
(10) Pub. No.: US 2005/0145092 A1
(43) Pub. Date: Jul. 7, 2005

(54) Brush stik

(76) Inventor: Jim L. Owens, Missouri City, TX (US)

Correspondence Address: EDWARD P. BLACK, P.O. BOX 11690, KLEIN, TX, 77391, US

(21) Appl. No.: 11/020,407

(22) Filed: Dec. 27, 2004

Related U.S. Application Data
(60) Provisional application No. 60/532,071, filed on Dec. 24, 2003.

(51) Int. Cl. G10D 13/02

(52) U.S. Cl. 84/422.1

(57) ABSTRACT

This invention discloses a drum stick into which a hollow cavity is drilled and which contains a brush assembly secured by an end cap. The brush assembly is retracted into the hollow stick until needed by a drummer, who then extends the brush out of the cavity with a snap of his wrist, and turns the drum stick over and uses the brushes. When not deeded by the drummer, the brushes are re-inserted into the cavity by pushing lightly on the end of the brush.

### I. BACKGROUND OF THE INVENTION

The drummer, or percussionist, is one of the more important members of any instrumental ensemble. It is the drummer who is responsible for setting and maintaining the tempo of the music. Further, the drummer creates different effects which ‘color’ the music being performed. One of the more common and important effects is the ‘brush’ sound. This is accomplished through use of a drum stick which has been modified to have a wire brush rather than a hard tip. The brush is used on both the drums and the cymbals at the drummer's station.

All drummers (according to music styles) at one time or another will use both a drumstick and a drum brush. Currently, the drummer has to have his sticks arranged for quick access when it in necessary to change between stick and brush. It often creates some awkwardness putting down one stick to reach for the other, especially if the music requires quick changes (slow to fast, etc.) This can result in loss of timing.

The present invention solves the problem of quick changes for the drummer. With just a flick of the wrist, the drummer will be able to convert this first retractable combination implement between drum stick and drum brush. Converting back to stick is almost as easy, the drummer simply pushes the brushes back into the cavity of the stick and resumes drumming.

### II. BRIEF SUMMARY OF THE INVENTION

The inventor has modified a regular, solid wooden drumstick by drilling a hole down the center of the stick and inserting a brush assembly which can be extended for use by a simple shake of the drummer's wrist. With the brushes extended, the drummer turns the stick over and uses the brush end until the music requires a return to drumming; at which time, the drummer places the end of the brushes against his leg and pushes down on the stick, which retracts the brushes back into the stick cavity. He then returns to drumming until the brushes are needed again.

### . BRIEF DESCRIPTION OF THE SEVERAL VIEWS OF THE DRAWING

The invention is illustrated as follows:

FIG. 1. shows a drumstick with the interior hollowed ready for the brush assembly to be inserted therein.

FIG. 2. shows the brush assembly prior to insertion into the stick cavity.

FIG. 3. shows a view of the end-cap which is placed over the hollow end of the stick and through which, the brush wires pass during extension. This figure also shows the ends of the brush extending slightly when the brush is in the retracted position. This figure also shows the attachment means securing the end cap to the drum stick. The end cap also serves to stop the brush extension so they stay inside the hollow stick end.

FIG. 4. shows a view of the end-cap with the brushes shown extending down into the hollow cavity of the drum stick.

FIG. 5 shows an end view of the end cap with its elongated hole, through which the brushes pass when extended.

FIG. 6 shows the invention with the brushes fully extended ready for use by the drummer.

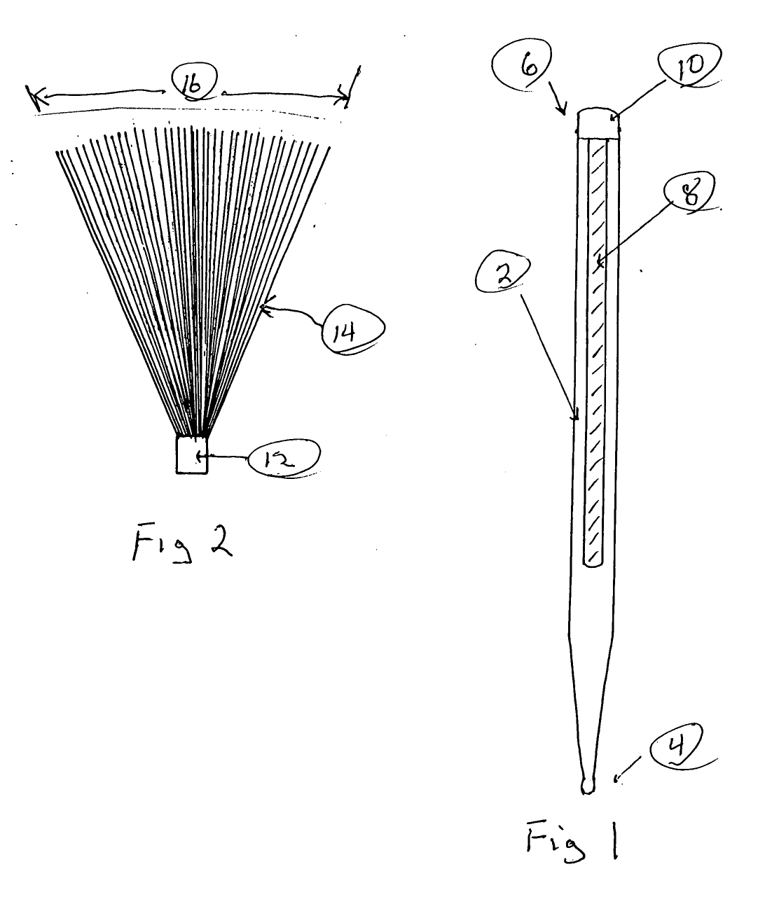

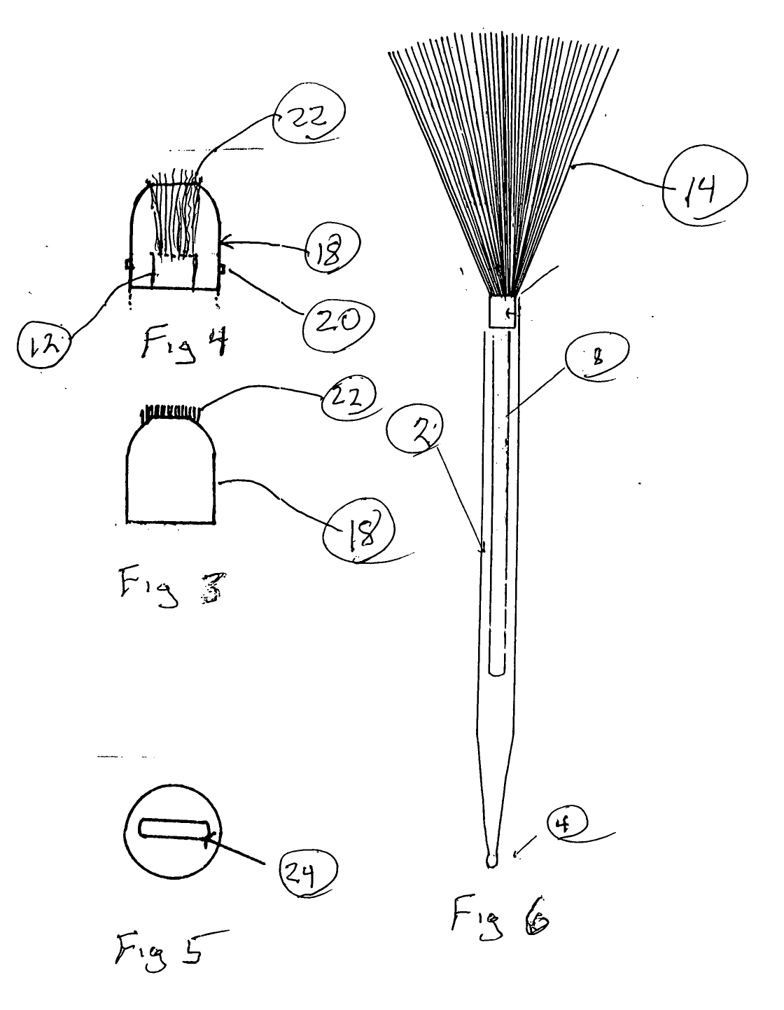

### IV. DRAWINGS

See included sheets.

### V. DESCRIPTION OF THE PREFERRED EMBODIMENT

A drumstick (2), having a drumming end (4) and a brush end (6) is drilled concentrically to form a centered cavity (8) from the top end of the drum stick to a depth of about 6¾″. This centered cavity houses the brush assembly (FIG. 2), which has a round base (12) into which stiffened wires (14) have been inserted and secured into the characteristic brush fan (16) used by drummers. An end cap (18) with an elongated, centered slot (24) is placed over the brush end (6) of the stick (2), and secured with a securing means (20), thus holding the brush assembly (FIG. 2) in place. When fully assembled, the end cap (18) has a very small length of protruding brushes exposed (22). The end cap, which holds the brush assembly from exiting the cavity, is secured to the drum stick, which also secures the brush inside the cavity.

The drummer, during the course of his performance, will hold the stick (2) with the end containing the brushes (6) up, and use the stick as a normal drumstick. When the brushes (14) are needed, he holds the stick firmly and gives it a brisk shake of his wrist, which is sufficient for the brushes (14) to be extended through the end cap (18) and be available for use. After finishing with the brushes (14), the drummer simply pushes the ends of the brush (14) lightly to retract them into the cavity of the drum stick (8) until needed again.

1. A drumstick having a multiplicity of ends, one end being adapted for drumming and a second end containing a hollow cavity in which a brush assembly is inserted, said brush assembly extending through an end cap containing a slit,
said end cap is secured to said second end of said drumstick with an attachment means;

2. The drumstick of claim 1 wherein said hollow cavity is concentrically drilled along the central axis of said drumstick.

3. The drumstick of claim 1 where said attachment means comprise set screws, rivets, brads, nails and shrink wrap.

4. The drumstick of claim 1 where said brush assembly consists of a circular tube in which a multiplicity of stiffened wires have been secured in a fan arrangement using a brush attachment means.

5. The drumstick of claim 4 where said brush attachment means comprises epoxy.
